(19) United States
(12) Patent Application Publication
(10) Pub. No.: US 2017/0372362 A1
(43) Pub. Date: Dec. 28, 2017

(54) Real-Time Competitive Information Delivery

(71) Applicant: Microsoft Technology Licensing, LLC, Redmond, WA (US)

(72) Inventors: Marcel Gavriliu, Snohomish, WA (US); Jie Liu, Medina, WA (US); Nissanka Arachchige Bodhi Priyantha, Redmond, WA (US); Michel Goraczko, Seattle, WA (US); Di Wang, Redmond, WA (US); Gerald Reuben DeJean, Woodinville, WA (US); Nagendra V. Kolluru, Redmond, WA (US); Murali Nallappa, Redmond, WA (US); Vaidyaraman Sambasivam, Redmond, WA (US); Manish Agrawal, Bellevue, WA (US); Srinivasa Reddy Neerudu, Redmond, WA (US); Dimitrios Lymberopoulos, Kirkland, WA (US); Mohammed Shoaib, Redmond, WA (US)

(21) Appl. No.: 15/192,810

(22) Filed: Jun. 24, 2016

(51) Int. Cl. G06Q 30/02

(52) U.S. Cl. CPC G06Q 30/0259; G06Q 30/0275; G06Q 30/0261; G06Q 30/0269

(57) ABSTRACT

Providing discounts to users in a physical store location. The method includes detecting that a user has stopped at a given location in the physical store. The method further includes, based on the location, identifying a set of products. The method further includes, providing an identification of the set of products to an ad server. At the ad server an auction is initiated between different product promoters to identify ads to be provided to the user. The method further includes, receiving from the ad server one or more ads to be provided to the user based on the results of the ad auction. The method further includes, providing the one or more ads to the user.

### BACKGROUND

### Background and Relevant Art

When users shop at brick and mortar stores, their shopping experience tends to be one size fits all. In particular, advertising tends to be shopper agnostic. The same advertisements are viewable by all shoppers throughout the store without any personalization for a particular shopper. Additionally, advertisers are limited to advertising campaigns that will be applied to all shoppers irrespective of their demographics or individual characteristics.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that includes acts for providing discounts to users in a physical store location. The method includes detecting that a user has stopped at a given location in the physical store. The method further includes, based on the location, identifying a set of products. The method further includes, providing an identification of the set of products to an ad server. At the ad server an auction is initiated between different product promoters to identify ads to be provided to the user. The method further includes, receiving from the ad server one or more ads to be provided to the user based on the results of the ad auction. The method further includes, providing the one or more ads to the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a retail store environment;

FIG. 2 illustrates a retail store, ad server, and recommender service; and

FIG. 3 illustrates a method of providing discounts to users in retail stores.

### DETAILED DESCRIPTION

Embodiments illustrated herein implement a new customer engagement channel targeting physical retail stores. This new channel enables retailers as well as product manufacturers to reach shoppers in a personalized fashion while in the physical store and right at the purchase decision making moment. With this channel, advertisements, such as coupons for products within the shopper's arm reach or relevant product recommendations, can be displayed to shoppers as they are about to make a purchase decision by picking up a product from the shelf and adding it to their shopping cart.

Embodiments can facilitate and implement micro-auctions between product promoters (e.g., advertisers, manufacturers, etc.) that take place at various opportunities to show an advertisement/offer (e.g., every time the shopping cart stops). Initially, retailers and product manufacturers can define ad campaigns at an ad server targeting specific locations in the store, products, types of shoppers, types of stores, location of stores etc. Each campaign is assigned a bid that the retailer or manufacturer is willing to pay for it to show up on a shopper's screen. The more specific the targeting, usually the higher the bid is going to be. When a shopper's shopping cart stops in the store, the user information (i.e., demographics, purchase history, shopping list if available, etc.) along with the shopper's current location in the store, and a list of the nearby products in the store is sent to a backend of the ad server. The ad server selects all active advertising campaigns that fit the current criteria, and an auction is run to rank the possible ads. The auction uses real-time physical information such as the location of the user and the nearby products to run the auction and select the right ad to display.

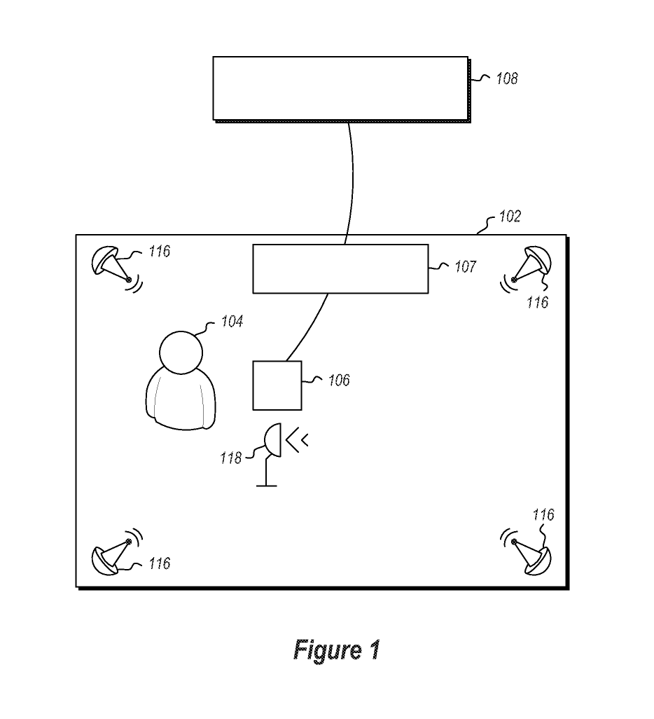

Referring now to FIG. 1 an example is illustrated. FIG. 1 illustrates a retail store 102. The user 104 (e.g. a shopper) is in the retail store 102. As the user 104 moves about the retail store 102, the user 104 may determine to stop and examine products available at the retail store 102. User 104 has a device 106. The device 106 is able to determine the user's location within the retail store 102. Once it is known that the user has stopped, at a particular location in the retail store 102, the device 106 can identify this information. Based on the location in the retail store 102, information about products near the user 104 or of interest to the user 104 may be identified by a store server 107 and transmitted to an ad server 108.

At the ad server 108, an auction may take place between various product promoters to compete for the opportunity to provide an advertisement to the device 106 and display the ad to the user 104. As will be discussed in more detail below, the auction may be based on a number of different factors which can be used to determine which product promoter wins the opportunity to display an ad at the device 106 to the user 104.

Thus, embodiments may include functionality for using the real-time location of the shopper in a physical retail store to identify/filter and rank the advertisement campaigns about products within the shopper's arm reach (or otherwise of interest to the shopper).

Embodiments may use information about the current shopping trip of the shopper, such as a shopping list for this trip or what the shopper has already put in the shopping cart to identify/filter and rank the advertisement campaigns about products within the shopper's arm reach (or otherwise of interest to the shopper).

Embodiments may use detailed information about the shopper, such as demographics, and purchase history to identify and/or filter and rank the advertisement campaigns about products within the shopper's arm reach (or otherwise of interest and/or available to the shopper).

Embodiments may use detailed information about the shopper's visited locations in this and previous shopping trips to identify and/or filter and rank the advertisement campaigns about products within the shopper's arm reach (or otherwise of interest or available to the shopper).

Embodiments may use the point-of-sale data from the physical retail store to link the advertisement campaigns to actual purchase or non-purchase events.

Embodiments may implement a process whereby promoters, such as retailers or product manufacturers, can run advertising campaigns on one or more of the following targeting criteria:

i) shopper's real-time location in the store

ii) shopper's purchase history

iii) shopper's shopping list

iv) shopper's previously visited locations in the store in this or previous trips

v) shopper's demographics

vi) physical store's geographical location

vi) physical store's house brands

etc.

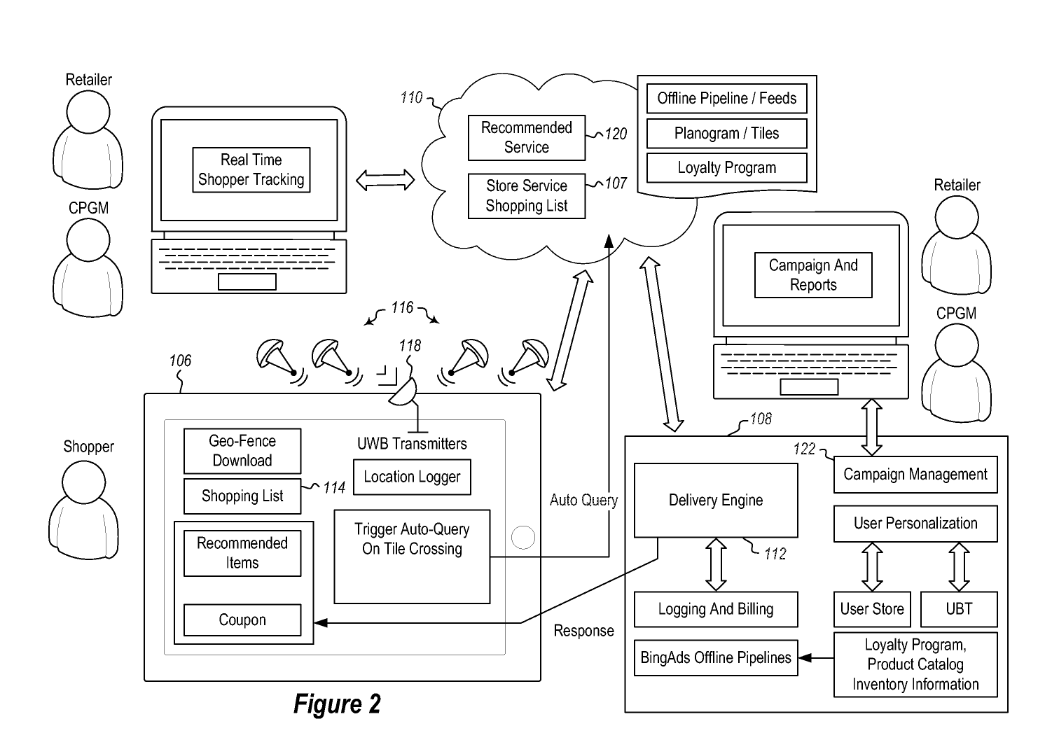

The following illustrates a detailed scenario example with reference to FIGS. 1 and 2. As a user 104 enters the retail store 102, the user 104 obtains a shopping cart and heads straight to the aisle with hot dogs. The shopping cart may have the device 106 attached to it. Alternatively or additionally, the device 106 may be the user's personal device such as the user's cell phone, tablet, or other device. The device 106 may represent the combination of a store provided device coupled to a user's personal device. Etc. A user can “sign-in” at this point. In particular, the user obtains a shopping cart and keys in a phone number on a screen on the device 106 or simply scans a customer loyalty card. This is how the system can know who the user is (demographics, history etc.) at the beginning of the shopping trip. When the user 104 stops at the hot dog area, an auto-query is triggered by the device 106 and potentially one or more other intervening devices or services as will be illustrated in more detail below, to the store service 107 (which may be located locally at the retail store 102 as illustrated in FIG. 1, or alternatively located in a cloud infrastructure 110 as illustrated in FIG. 2, with the location coordinates of the user 104 in the retail store 102.

The store service 107 then translates the users location to a list of UPC codes of all the products that are within the user's 104 arm reach (or otherwise available to the user 104), and sends a call to an ad delivery engine 112 (such as the Bing ad delivery engine available from Microsoft Corporation, of Redmond, Wash.) with this UPC code list.

The delivery engine 112 retrieves all relevant campaigns for the UPC codes submitted with the query, and initiates a real-time auction for the products close to the user 104's arm reach.

The delivery engine 112 returns one or more coupons/offers which are displayed in the user 104's smart shopping cart (e.g., the device 106) before he makes a purchase decision.

The ad server 108 also provides the reports that reliably evaluate the effectiveness of each coupon impression and the detailed shopper's actions (i.e., shopper ignored coupon, shopper placed product in cart, shopper purchased product) in response to the coupon impression.

The user 104 uses the device 106 to navigate the retail store 102 and populate a shopping list 114.

In some embodiments, the retail store 102 is segregated into tiles to determine which products are to be targeted.

Transmitters 116, such as ultra-wide-band (UWB) transmitters, such as those available from decaWave of Dublin, Ireland, installed in the stores send precise signals that can be received by a receiver 118 used to determine where the user 104 is located.

The device 106 continuously sends queries to the cloud (recommendation service 120 and store service 107) with the coordinates of the user 104.

The recommendation service 120 provides recommendations for products. The store service maintains 107 the shopping list and determines which coupon to display to the user 104 by calling the ad server 108 delivery engine 112.

When the user 104 loads the shopping list 114 onto the device 106, the recommendation service 120 in the cloud makes product recommendations, for example, based on one or more of the following: current store promotions, the users shopping list 114, purchase history for the user 104, current location in the store, etc.

When the user 104 stops to check or pick a product, an online auction is triggered at the ad server 108 based on the coordinates of the user 104 in the tile and individualized real time offers for products within the user's arm-reach (or otherwise available to the user) are shown. These may be nearby items that the system predicts that the user has a high probability of purchasing. The offers that are shown to the user may be determined via a real time auction triggered by a call to the delivery engine 112 of the ad server 108. The delivery engine 112 determines the best candidates based on various criteria such as bidding information, relevancy, loyalty program user purchase history, product inventory and other factors.

When the user redeems a relevant offer or purchases a product from the shopping list 114, a call is sent to the recommendation service 120 in the cloud infrastructure 110 which returns recommendations for other products that are frequently brought together or that are otherwise relevant to the user's profile and/or location in the store.

Below is a specific example. Consider the following data tables:

Catalog Feed

| | |
|---|---|
| Cheese | Tillamook |
| | Kraft |
| | Laughing Cow |
| | Lucerne |
| Ketchup | Heinz |
| | Hunts |
| | Del Monte |
| | Safeway |

Campaign Setup (Campaign → Ad Group → Product Listing)

| Campaign | Ad Group | | Tillamook |
|---|---|---|---|
| | Time Zone | | PST |
| | Budget | | 100,000 |
| | Location | | WA |
| | Ad Schedule | | All Days, All hours |
| | Demographics | Gender | Male - 10% bid boost |
| | | Age | 25-34 15% bid boost |
| | Device | NA | NA |
| | In-Store location | | Dairy |
| | User Segments | | Tillamook Buyer |

| | |
|---|---|
| Product Listing | Product Listing ID should be mapped to the Catalog ID |

The retail store 102 is divided into grids and each grid can have multiple Products. Each Product in the retail store 102 is identified by a unique UPC Code. Each Product contains multiple consumer packaged goods manufacturer (CPGM)/brands.

Assume Grid ID G1 contains products Pr1 (cheese) and Pr2 (Ketchup) mapped to UPC1 and UPC2 respectively. When the user 104 (identified in this example as User1) enters and stops in G1, the device 106 sends a call to the store service 107 with Lat/Long, Shop1 and User1. The store service 107 does a planogram look-up and sends query (Q1 with UPC1 and UPC2).

The delivery engine 112 performs one or more real time auctions,

| Pr1 Auction | Pr2 auction |
|---|---|
| Tillamook | Heinz |
| Kraft | Hunts |
| Laughing Cow | Del Monte |
| Lucerne | Safeway |

and returns the offers: The Offers/coupons are displayed to user1

| | |
|---|---|
| Heinz | Kraft |

Embodiments may include functionality for allowing product promoters to create and manage ad campaigns that can automatically participate in the auctions. For example, embodiments may include a user interface that allows an ad promoter to access the ad server 108 sign up page and create a new ad server 108 account or log-into an existing account.

The following illustrates an example of creating a new store and managing offers.

The product promoter creates a store in the ad server 108 merchant center 122.

The product promoter can identify stores in which products are sold and which products are sold. Thus, the product promoter can identify products that the product promoter wants to promote in the stores.

The product promoter can create and/or edit a feed file with the list of offers which the product promoter will later upload to the ad server 108 system using a catalog management interface. The product promoter then uploads the offer feed file with all the offers he wants to show in the stores using catalog management tools. Alternatively or additionally, the product promoter can upload the catalog feed files via other methods like FTP and Auto Download.

The following illustrates details with respect to campaign management.

The product promoter logs into their ad server 108 account and clicks on a campaign element to create a new ad (e.g., a coupon) campaign. The product promoter can create the campaign and enter various campaign setting details based on the product promoter's preferences. For example, the product promoter can set a total budget, budget smoothing to specify the rate the budget is spent (e.g., dollars per day), time zone, etc. The product promoter can select products and stores for the campaign. The product promoter can select the schedule for the campaign (Start date/End date).

In some embodiments, the product promoter can create different bids for different ad groups for the campaign, such as the ad groups illustrated above in the Campaign Setup table. For example, the product promoter creates a new ad group using the desired filters for the products. The product promoter can select products, such as by selecting UPC Codes. The product promoter can select stores, such as by selecting a combination of Store ID, Store Location and User Segment filters desired to create a target ad group.

The product promoter can choose to create different ad groups to promote products differently across multiple different stores. For example, the product promoter can provide a 10% discount to users of one store in one ad group and 12% discount for users of a different store in a different ad group such as as is illustrated above in the campaign setup table.

The product promoter can create different ad groups for different targeting criterion for the ad campaign. For example, one ad group in the ad campaign can target all shoppers that have kids. For example, in some such embodiments, the product promoter can choose to increase the coupon discount from 10% to 12% for shoppers that have kids.

The product promoter can then assign a bid to each ad group. This bid will be used to determine which advertisements are shown to the user 104. The product promoter can assign various different bids for various different ad groups and user segments.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

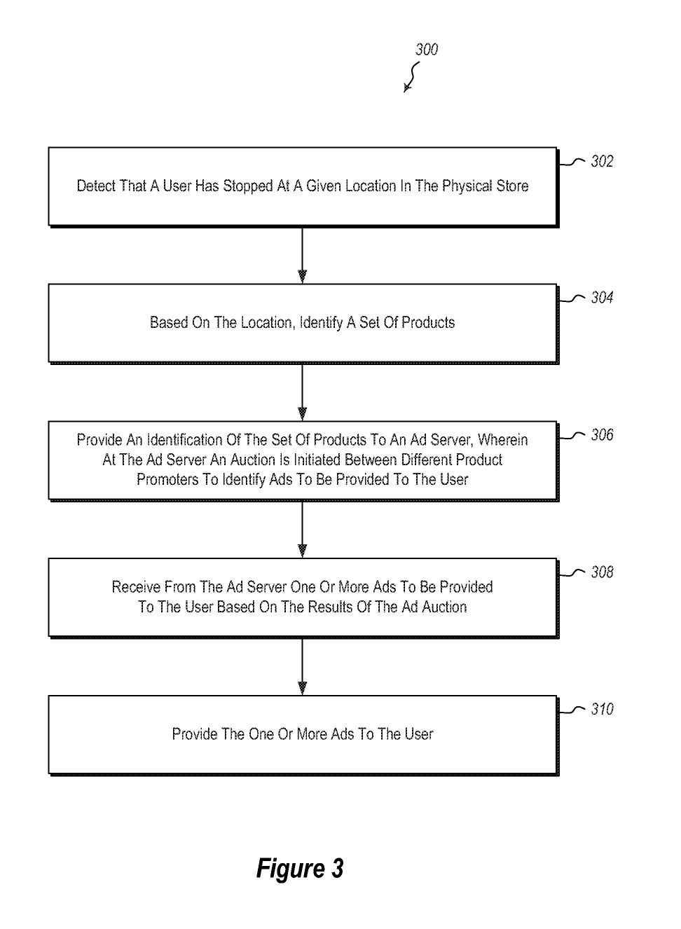

Referring now to FIG. 3, a method 300 is illustrated. The method 300 includes acts for providing discounts to users in a physical store location.

The method 300 includes detecting that a user has stopped at a given location in the physical store (act 302).

The method 300 further includes, based on the location, identifying a set of products (act 304).

The method 300 further includes, providing an identification of the set of products to an ad server, wherein at the ad server an auction is initiated between different product promoters to identify ads to be provided to the user (act 306).

The method 300 further includes, receiving from the ad server one or more ads to be provided to the user based on the results of the ad auction (act 308).

The method 300 further includes, providing the one or more ads to the user (act 310).

The method 300 may further include providing information about the user to the ad server. For example, the information may include one of more of user identifiers, history of past purchases relevant to the set of products, demographic information, segment information (for example, is the user a working mom, cereal lover, brand fan boy, etc.) medical information (for example, information about a user's allergies, diets, restrictions, medications, etc.) fitness targets, lifestyles, shopping context (for example, what is in the cart, other sections in the store, other delivered coupons, etc.) or other information.

The method 300 may further include providing information about the store. For example, such information may include geographic location information, information identifying a store chain or franchise information, neighborhood demographics in the neighborhoods proximate the store, store layout or type (e.g., supercenter vs. corner store), store promotions, etc.

The method 300 may further include identifying the products based on a distance from the location (and either using to send or as part of bidding algorithm)

The method 300 may further include providing to the product promoters who will be participating in the auction pricing and bidding guidance. For example, the bidding guidance may include demographics, user segmentation, location in store, store chains or franchise, store location, successful price points (for winning bids and/or coupon values), statistical success rates, etc.

The method 300 may further include updating retargeting and analytics. For example, this may be done for a particular user, for an ad campaign, for a given store, for a given store location, etc.

The method 300 may be practiced where the auction is based on one or more of a bidding price from a promoter, actual discount values for coupons, distance of product from the location, or other factors.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system comprising
one or more processors; and
one or more computer-readable media having stored thereon instructions that are executable by the one or more processors to configure the computer system to provide discounts, including instructions that are executable to configure the computer system to perform at least the following:
detect that a user has stopped at a given location in the physical store;
based on the location, identify a set of products;
provide an identification of the set of products to an ad server, wherein at the ad server an auction is initiated between different product promoters to identify ads to be provided to the user;
receive from the ad server one or more ads to be provided to the user based on the results of the ad auction; and
provide the one or more ads to the user.

2. The computing system of claim 1, wherein the one or more computer-readable media further have stored thereon instructions that are executable by the one or more processors to provide information about the user to the ad server, and wherein the auction is based on the information about the user.

3. The computing system of claim 2, wherein the information about the user comprises one or more of a user identifier, history of past purchases relevant to the set of products, demographic information, segment information, medical information, fitness targets, lifestyle information, or shopping context.

4. The computing system of claim 1, wherein the one or more computer-readable media further have stored thereon instructions that are executable by the one or more processors to provide information about the store, and wherein the auction is based on the information about the store.

5. The computing system of claim 4, wherein the information about the store comprises one or more of geographic location, store franchise information, neighborhood demographics, store layout, store type, or store promotions.

6. The computing system of claim 1, wherein the one or more computer-readable media further have stored thereon instructions that are executable by the one or more processors to identify the products based on a distance from the location.

7. The computing system of claim 1, wherein the auction is based on one or more of bidding price from promoters, actual discount values, or distance of product from locations.

8. A method of providing discounts to users in a physical store location;
detecting that a user has stopped at a given location in the physical store;
based on the location, identifying a set of products;
providing an identification of the set of products to an ad server, wherein at the ad server an auction is initiated between different product promoters to identify ads to be provided to the user;
receiving from the ad server one or more ads to be provided to the user based on the results of the ad auction; and
providing the one or more ads to the user.

9. The method of claim 8, further comprising providing information about the user to the ad server, and wherein the auction is based on the information about the user.

10. The method of claim 9, wherein the information about the user comprises one or more of a user identifier, history of past purchases relevant to the set of products, demographic information, segment information, medical information, fitness targets, lifestyle information, or shopping context.

11. The method of claim 8, further comprising providing information about the store.

12. The method of claim 11, wherein the information about the store comprises one or more of geographic location, store franchise information, neighborhood demographics, store layout, store type, or store promotions.

13. The method of claim 8, further comprising identifying the products based on a distance from the location.

14. The method of claim 8, wherein the auction is based on one or more of bidding price from promoters, actual discount values, or distance of product from locations.

15. A method of providing discounts to users in a physical store location;
receiving an indication that a user has stopped at a given location in the physical store;
receiving an indication of a set of products based on the location;
initiating an auction between different product promoters, based on the indication of the set of products, to identify ads to be provided to the user;
providing one or more ads to a user based on the results of the ad auction.

16. The method of claim 15, wherein the auction is based on one or more of bidding price from promoters, actual discount values, or distance of product from locations.

17. The method of claim 15, further comprising receiving information about the user to the ad server, and wherein the auction is based on the information about the user.

18. The method of claim 15, further comprising receiving information about the store, and wherein the auction is based on the information about the store.

19. The method of claim 15, further comprising providing to product promoters who will be participating in the auction, pricing and bidding guidance.

20. The computing system of claim 19, wherein the bidding guidance comprises at least one of demographics, user segmentation, location in store, store franchise information, store location, successful price points or statistical success rates.
